(19) United States
(12) Patent Application Publication
(10) Pub. No.: US 2016/0302401 A1
(43) Pub. Date: Oct. 20, 2016

(54) Fishing Sinker

(71) Applicant: Jason Clive Grundy, Narangba (AU)

(72) Inventor: Jason Clive Grundy, Narangba (AU)

(21) Appl. No.: 15/096,403

(22) Filed: Apr. 12, 2016

(30) Foreign Application Priority Data
Apr. 20, 2015 (AU) 2015901417

(51) Int. Cl. A01K 95/02; A01K 91/03

(52) U.S. Cl. CPC A01K 95/02; A01K 91/03

(57) ABSTRACT

A fishing sinker includes a sinker body with a bore formed through it. A unidirectionally displaceable insert is received in the bore with a passage for line formed through the insert. A friction reducing sleeve is located between the bore and the insert and is fast with the sinker body. The insert is unidirectionally displaceable by virtue of it having an enlarged head that is incapable of proceeding through a narrow elongate portion of the sinker bore. Consequently the insert can only egress from the sinker in one direction. The sinker is designed to make it difficult for fish to feel any jerking or hesitation on the line as they take a baited hook so that they are not immediately alerted to the presence of fishing tackle.

This application takes the benefit of and in turn claims priority under 35 USC §119 to Australian Provisional Patent Application No. 2015901417 filed on 20 Apr. 2015, the contents of which are herein incorporated by reference.

### TECHNICAL FIELD

The present invention relates to angling and particularly to an improved item of fishing tackle.

### BACKGROUND

Any references to methods, apparatus or documents of the prior art are not to be taken as constituting any evidence or admission that they formed, or form part of the common general knowledge.

The inventor is a keen angler that has fished for many years in different conditions. From his years of experience the inventor has observed that fish are wary of fishing tackle and that in particular they are sensitive to whether or not the sensation of running with bait that is on a hook, prior to the fish being caught on the hook, is natural or rather if it feels artificial. In the event of it feeling artificial many fish will sense that something is wrong and then drop the bait. Such a situation is very frustrating for an angler since the angler will initially see the reel running and so have expectations for making a catch, only for those hopes to be dashed, apparently for no reason.

The inventor has hypothesized that a primary reason for the above problem is that the fish is able to sense vibrations and hesitations in the fishing line as it runs through a fishing sinker on the line. For example, FIG. 1 depicts a common fishing tackle arrangement wherein a sinker 2 is disposed between two swivels 4, 6 on a line 10. The line from the near swivel 4 is wound around a reel (not shown) whereas the line from the far swivel terminates on the hook. The purpose of the swivels is prevent twisting in the line as it uncoils from the reel. With reference to FIG. 2, after casting the hook, line and sinker the sinker 2 may become stuck on the bottom of the water body. In that case, if a fish picks the baited line 10 up in its mouth and runs with it then, as the near swivel 4 is pulled against the sinker 2 the fish will feel a strong hesitation, e.g. a jerk or vibration, in the line and so will often drop the bait rather than swallowing it and becoming caught on the hook.

After having come to comprehend the above problem the inventor has conceived of an improvement to fishing tackle to address this problem which is of benefit to other anglers in addition to the inventor and which will now be explained.

### SUMMARY OF THE INVENTION

According to a first embodiment of the present invention there is provided a fishing sinker including: a sinker body with a bore therethrough; a unidirectionally displaceable insert received in the bore and having a passage for line therethrough.

Preferably a sleeve is located between the bore and the insert and is fast with the sinker body.

In a preferred embodiment of the invention the bore comprises an elongate portion of a first diameter and a head portion of a second diameter, the second diameter being greater than the first diameter.

Preferably the sleeve is located along the elongate portion and not along the head portion of the bore.

Preferably the insert is formed with an elongate portion and a head portion which respectively correspond to the internal space of the sleeve and of the head of the bore.

It will be understood that the insert is unidirectionally displaceable by virtue of its enlarged head being incapable of proceeding through the narrow elongate portion of the bore. Consequently the insert can only egress from the sinker in one direction.

According to a further aspect of the present invention there is provided a fishing sinker including a heavy metal body with a bore therethrough and a sleeve lining the bore to encourage free movement of line running through the bore.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements. Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 depicts a typical prior art sinker and two swivel fishing tackle arrangement.

FIG. 2 illustrates the prior art tackle arrangement of FIG. 1 in use and illustrates how the sinker may become snagged on the bottom of the water.

FIG. 3 is a cross section through a sinker according to a preferred embodiment of the present invention.

FIG. 4 is an exploded and perspective view of the sinker of FIG. 3.

FIG. 5 shows the sinker of FIG. 3 in use during casting of the sinker.

FIG. 6 shows the sinker of FIG. 3 in use shortly after a fish has taken the bait, but not been caught on the hook, and is running with the line moving through the sinker.

FIG. 7 shows the sinker of FIG. 3 in use subsequent to the state depicted in FIG. 6 wherein a near swivel on the line has passed through the sinker.

FIG. 8 is a cross section through a sinker according to a further embodiment of the present invention.

FIG. 9 is a cross section through a less preferable version of the sinker of FIG. 3, which does not include a friction reducing sleeve between the body of the sinker and the insert.

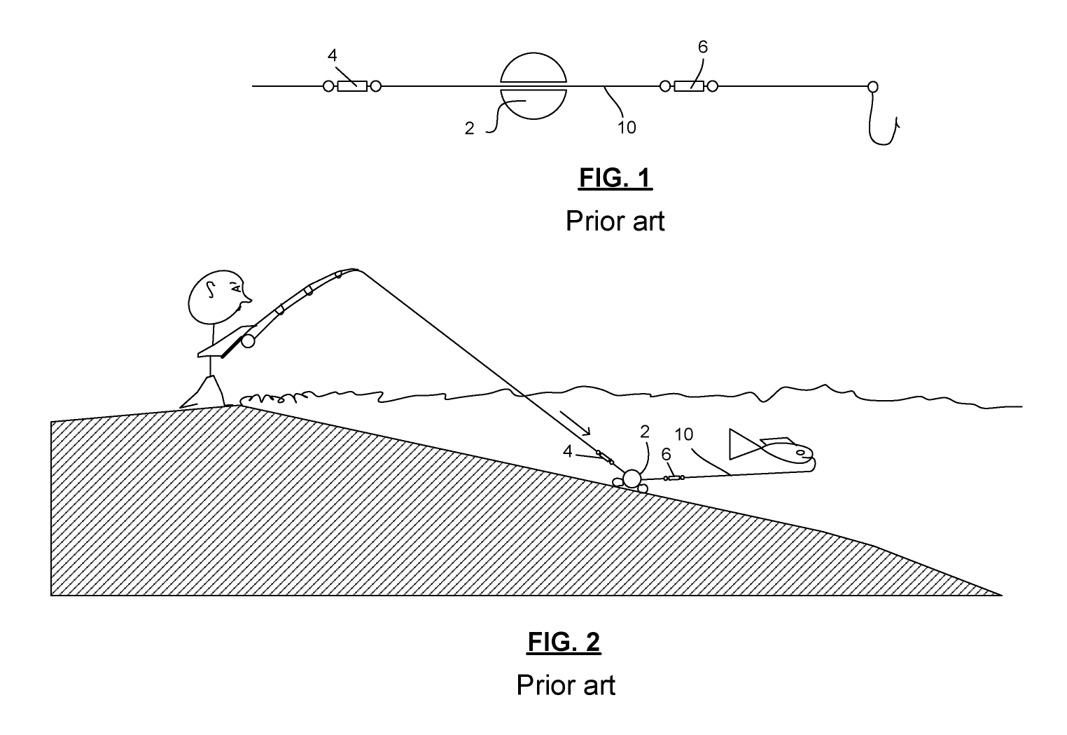

### DETAILED DESCRIPTION

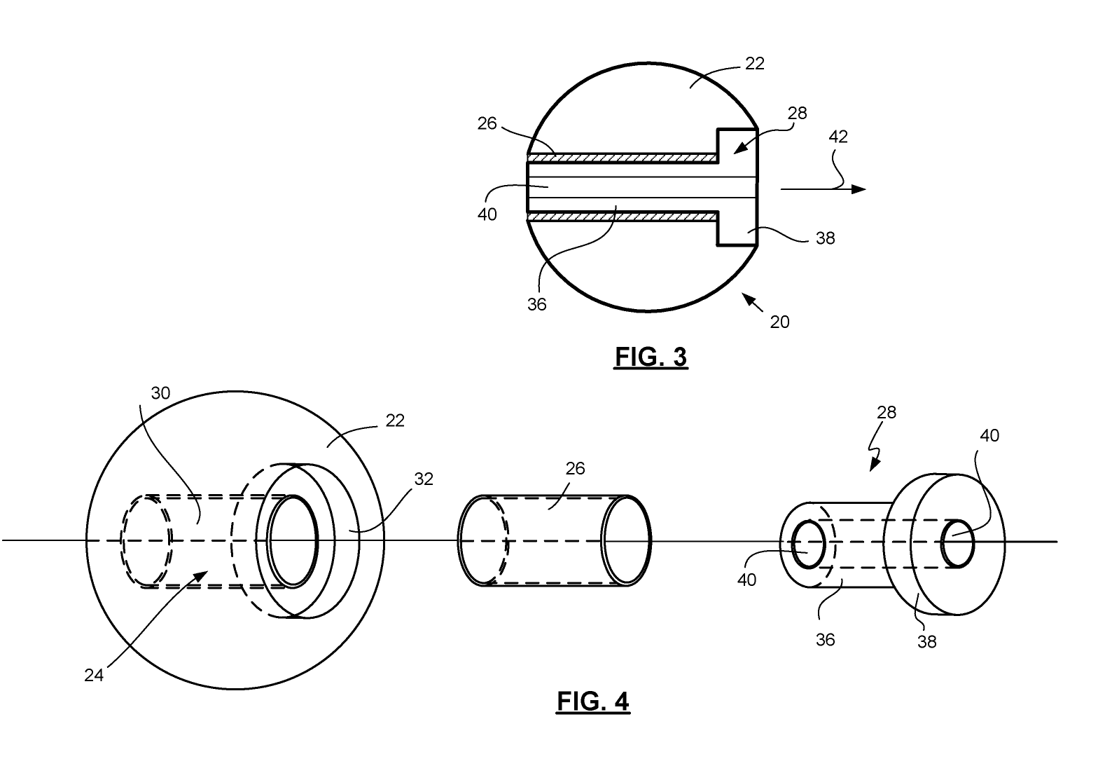

Reference will now be made to FIG. 3, which is a cross section through a fishing sinker 20 according to a preferred embodiment of the present invention and also to FIG. 4, which is an exploded perspective view of the fishing sinker 20.

The fishing sinker 20 includes a sinker body in the form of a heavier-than-water body 22 which is typically a sphere made of a dense metal such as lead with a bore 24 formed therethrough. The bore 24 comprises an elongate portion 30 of a first diameter and a head portion 32 of a second diameter with the diameter of the head portion being greater than the diameter of the elongate portion.

A sleeve 26, which is typically made of a synthetic material such as nylon, is located between the bore and the insert and is fastened to the bore of the heavy body so that it is not readily dislodged therefrom.

In the preferred embodiment of the invention that is presently being discussed the sleeve 26 is located along the elongate portion 30 and does not proceed along the head portion 32 of the bore 24.

A unidirectionally displaceable insert 28 is provided which is cylindrical in form and which is configured with an elongate portion 36 that terminates at one end in a head portion 38. The elongate portion 36 and the head portion 38 of the insert 28 are shaped to respectively correspond to the internal spaces of the sleeve 30 and of the head 32 of the bore 24.

The insert 28 is formed with a coaxial passage 40 through which a fishing line passes in use as will be explained. The insert 28 and the sleeve 26 are made of materials, such as nylon, that slide easily over each other with minimal friction.

It will be understood that the insert 28 is unidirectional by virtue of its enlarged head 38 being incapable of proceeding through the sleeve 26 which is held in the narrow elongate portion 30 of the bore 24 since the head 38 of the insert is too wide to pass. Consequently the insert can only egress from the sinker in one direction, i.e. direction 42 as indicated in FIG. 3.

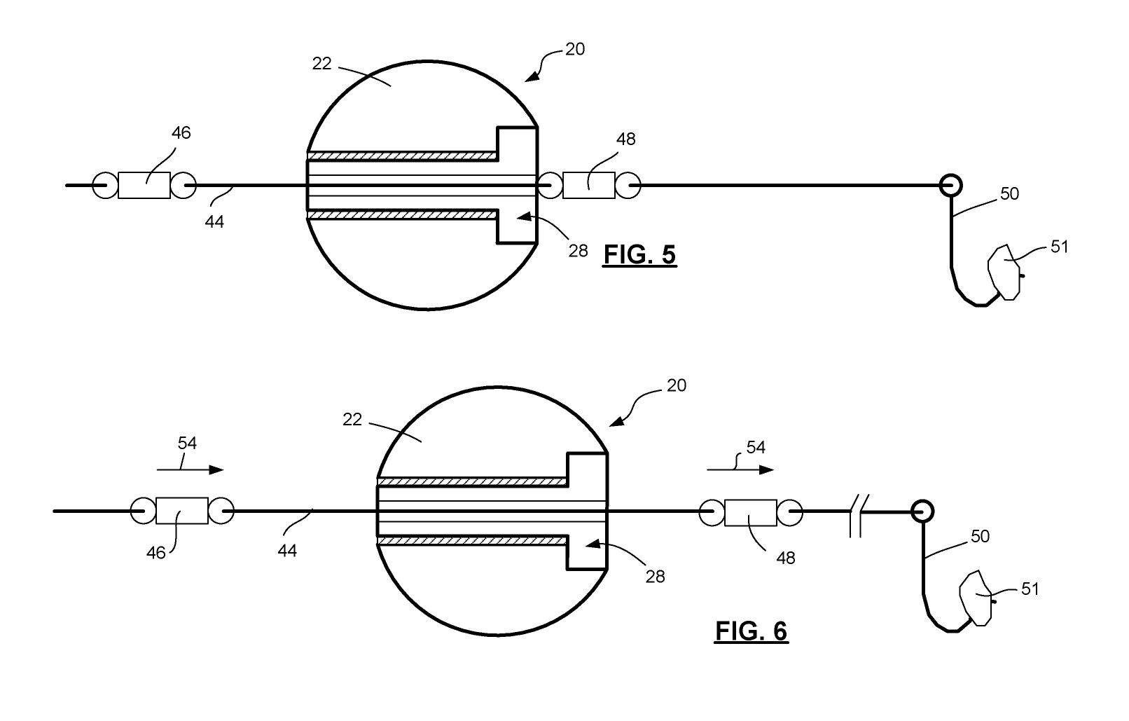

Referring now to FIG. 5, in use the sinker 20 is strung on a line 44. A near (relative to the reel) swivel 46 and a far swivel 48 are tied into the line on either side of the sinker 20. The line terminates on a fishing hook 50 which bears bait 51 as shown. FIG. 5 shows the sinker during a casting operation wherein the sinker 20 is thrown along the line so that the head of the insert 28 is forced into abutment with the far swivel 48 as shown in FIG. 5. The swivels 46 and 48 are too wide to pass through the passage 40 of the insert 28. Since the insert is unidirectional the casting action does not cause the insert to be released from the sinker and so casting of the baited hook 52 proceeds in the usual fashion.

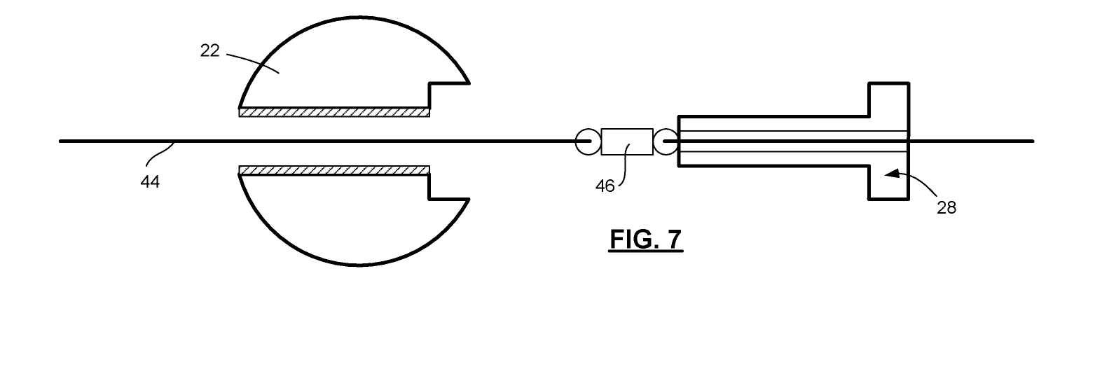

Referring now to FIG. 6, after the line has been cast the bait on the hook 52 is taken by a fish so that the line 44 proceeds through the sinker in the direction 54 indicated. This motion causes the near swivel 46 to abut the near end of the insert and so to cause the insert 28 and the near swivel 46 to proceed out of the heavy body 22 of the sinker as shown in FIG. 7. The action of the near swivel 46 abutting the insert and causing it to exit from the heavy body causes much less hesitation, e.g. jerking and tension, on the like than would be the case if the swivel 46 simply impacted on the near side of a conventional sinker and was unable to proceed relatively unhindered through the sinker. Consequently, the presence of the sinker 20 and so of the fishing tackle is not made obvious to the fish and there is a greater chance that the fish will swallow the bait and become caught on the hook.

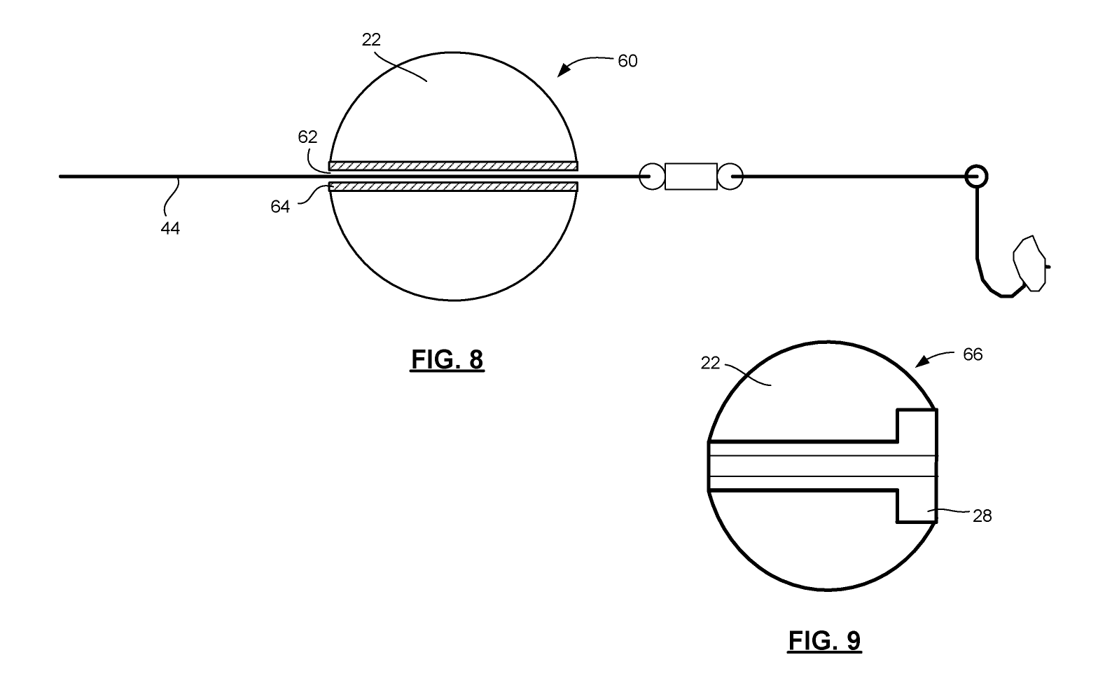

A sinker 60 according to an alternative embodiment of the invention is depicted in FIG. 8 in use. The sinker 60 is envisaged for situations where the near swivel is not required and is not present. Sinker 60 includes a spherical sinker body in the form of a heavier-than-water body 22 with a diametral bore 62 formed therethrough. The sinker body could have other shapes than spherical if desired. A narrow sleeve 64 of a synthetic material that presents a low coefficient of friction lines the inside of the bore. This second embodiment operates by improving the free running of the line 44 through the sinker 60 in order to reduce the likelihood of snagging or catching between the sinker and the line which would cause hesitations in the motion of the line to be transmitted to the fish, thereby alerting it of the presence of the tackle and causing it to fail to take the bait.

FIG. 9 depicts a further sinker 66 according to another embodiment of the present invention. The sinker 66 is entirely similar to that of sinker 20 save that the sleeve 26 is not present and instead the insert 28 makes direct contact with the heavy body 22 of the sinker. It will be realised that since the sleeve 26 is not present the friction between the insert 28 and the heavy body 22 is greater so that there is a higher likelihood of vibrations through the line passing on to the fish upon the near swivel abutting the insert 28 during use.

In compliance with the statute, the invention has been described in language more or less specific to structural or methodical features. The term “comprises” and its variations, such as “comprising” and “comprised of” is used throughout in an inclusive sense and not to the exclusion of any additional features. It is to be understood that the invention is not limited to specific features shown or described since the means herein described comprises preferred forms of putting the invention into effect. For example, in the preferred embodiment of the invention that is illustrated in FIGS. 3 and 4 the central bore 30, body 36 and head 38 are all cylindrical, i.e. they have a circular cross section. It will be realised that they could be of another cross sectional shape though, for example square or rectangular.

The invention is, therefore, claimed in any of its forms or modifications within the proper scope of the appended claims appropriately interpreted by those skilled in the art.

Throughout the specification and claims (if present), unless the context requires otherwise, the term “substantially” or “about” will be understood to not be limited to the value for the range qualified by the terms.

Any embodiment of the invention is meant to be illustrative only and is not meant to be limiting to the invention. Therefore, it should be appreciated that various other changes and modifications can be made to any embodiment described without departing from the spirit and scope of the invention.

I claim:

1. A fishing sinker comprising:
a sinker body with a bore therethrough;
a unidirectionally displaceable insert received in the bore and having a passage for line therethrough.

2. The sinker according to claim 1, wherein a sleeve is located between the bore and the insert and is fast with the sinker body.

3. The sinker according to claim 1, wherein the bore comprises an elongate portion and a head portion.

4. The sinker according to claim 3, wherein the elongate portion is cylindrical with a first diameter and the head portion is cylindrical with a second diameter, the second diameter being greater than the first diameter.

5. The sinker according to claim 4, wherein the sleeve is located along the elongate portion and not along the head portion of the bore.

6. The sinker according to claim 4, wherein the insert is formed with the elongate portion and the head portion to respectively correspond to internal space of the sleeve and of the head of the bore.

7. The fishing sinker according to claim 2, wherein the sleeve is made of nylon.
